(19) United States
(12) Patent Application Publication
(10) Pub. No.: US 2008/0151064 A1
(43) Pub. Date: Jun. 26, 2008

(54) IMAGE PROCESSING APPARATUS AND IMAGE PICKUP APPARATUS

(75) Inventors: Mitsuhiro Saito, Utsunomiya-shi (JP); Hidetoshi Tsubaki, Utsunomiya-shi (JP); Takahiro Oshino, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/956,812

(22) Filed: Dec. 14, 2007

(30) Foreign Application Priority Data
Dec. 21, 2006 (JP) 2006-344568

(51) Int. Cl. H04N 5/228

(52) U.S. Cl. 348/208.4; 348/E05.031

(57) ABSTRACT

An image processing apparatus capable of performing processing for reducing a shake in the image including a distortion without performing processing for reducing the distortion is disclosed. The apparatus includes a shake detecting part that detects a shake in a first image area of an input image including a distortion, a shake information generating part that generates shake information on a shake in a second image area of the input image based on the shake detected by the shake detecting part, and a shake reduction processing part that performs image processing for reducing the shake in the second image area based on the shake information without performing image processing for reducing the distortion on the input image.

### BACKGROUND OF THE INVENTION

The present invention relates to an image processing apparatus and an image pickup apparatus including the same for obtaining an output image where a shake is corrected (reduced) by coordinate transformation processing performed on an input image.

A method of correcting the shake of the image caused by hand jiggling in the image pickup apparatus such as a camera includes so-called electronic image stabilization.

The electronic image stabilization detects the shakes (an amount of the shake and a direction thereof) between serial frame images obtained by the image pickup element using image processing technology, and stabilizes the output image by shifting an output area (clipping area) so as to cancel the shake.

Japanese Patent No. 2,586,686 discloses electronic image stabilization that detects the shake as a motion vector using a least squares method at every pixel or every small block of the input image and calculates parameters of affine transformation processing for performing image stabilization on a whole part of the image based on the motion vector.

Japanese Patent No. 2,506,500 discloses electronic image stabilization as follows. First of all, shakes in some areas of the image are detected as movement amounts, and a transformation coefficient for representing the movement of the whole image is calculated using the movement amounts. Then, a predicted movement amount in a remaining area of the image is calculated from the obtained transformation coefficient. Then, the predicted movement amount and the movement amount actually detected from the image are compared, and an area in which an error is equal to or less than a threshold value is extracted as an area in which the same movements are performed. Shake detection and image stabilization (shake correction) are thus realized with high accuracy.

However, the image stabilization disclosed in Japanese Patent Nos. 2,586,686 and 2,506,500 have problems as follows.

The method disclosed in Japanese Patent No. 2,586,686 has a premise that the shake amount of the whole image should be uniform. Due to the premise, the method can not realize image stabilization accuracy that is sufficient enough for an image including a distortion like an image picked up using a wide-angle lens and an image picked up using a lens such as a fish-eye lens of which projection method is not a perspective projection method.

The method disclosed in Japanese Patent No. 2,506,500 does not take account of the distortion included in the image either. An apparent shake of the image with respect to a camera shake in the area including the distortion differs from that in the area not including the distortion. Therefore, even though the predicted movement amount obtained from the transformation coefficient representing the movement of the whole image and the movement amount actually detected are compared, which areas have the same movements is not accurately determined, thereby the image stabilization can not be accurately performed.

When image stabilization is performed on the image including the distortion, it is possible to generate the image including no distortion by performing image transformation processing on the image including the distortion as a pre-processing, perform shake detection processing and image stabilization on the image including no distortion, and re-transform to the image originally including the distortion after stabilizing the image. The method, however, increasing an amount of calculation slows down the speed of generating an output image. Furthermore, it is true that quality of the image is deteriorated by performing the image transformation processing.

### BRIEF SUMMARY OF THE INVENTION

The present invention provides an image processing apparatus and an image pickup apparatus capable of performing shake reduction processing on an image including a distortion without performing distortion reduction processing.

An image processing apparatus as one aspect of the present invention includes a shake detecting part that detects the shake in a first image area of an input image including the distortion, a shake information generating part that generates shake information on a shake in a second image area of the input image based on the shake detected by the shake detecting part, and a shake reduction processing part that performs image processing for reducing the shake in the second image area based on the shake information without performing image processing for reducing the distortion on the input image

An image pickup apparatus as another aspect of the present invention includes an image pickup system that generates an input image using an optical system and an image pickup element and the above image processing apparatus.

Further, an image processing method as still another aspect of the present invention includes the steps of detecting a shake in a first image area of an input image including a distortion, generating shake information on a shake in a second image area of the input image based on the shake detected in the first image area and performing image processing for reducing the shake in the second image area based on the shake information without performing image processing for reducing the distortion on the input image.

Other aspects of the present invention will be apparent from the embodiments described below with reference to the drawings.

### BRIEF DESCRIPTION OF THE DRAWINGS

FIG. 1 is a block diagram showing the configuration of an image pickup apparatus that is Embodiment 1 according to the present invention.

FIG. 2 is a flowchart showing image stabilization in Embodiment 1.

FIG. 3 is a diagram showing a perspectively-projected image.

FIG. 4 is a diagram showing a fish-eye image by an orthogonal projection method.

FIG. 5 is a block diagram showing the configuration of the image-pickup apparatus that is Embodiment 2 according to the present invention.

FIG. 6 is a flowchart showing the image stabilization in Embodiment 2.

FIG. 7 is a diagram showing a relationship between a view angle and an image height on the perspectively-projected image and that on the fish-eye image.

FIG. 8 is a block diagram showing the configuration of the image pickup apparatus that is Embodiment 3 according to the present invention.

FIG. 9 is a flowchart showing the image stabilization in Embodiment 3.

FIG. 10 is a diagram showing a relationship between an angle and the magnitude of a motion vector.

FIG. 11 is a block diagram showing the configuration of the image pickup apparatus that is Embodiment 4 according to the present invention.

FIG. 12 is a flowchart showing the image stabilization in Embodiment 4.

FIG. 13 is a diagram showing a relationship between a coordinate position and the motion vector for every zoom position.

FIG. 14 is a schematic diagram showing the configuration of the image processing apparatus that is Embodiment 5 according to the present invention.

### DETAILED DESCRIPTION OF THE PREFERRED EMBODIMENTS

Exemplary embodiments of the present invention will be described below with reference to the accompanied drawings.

### Embodiment 1

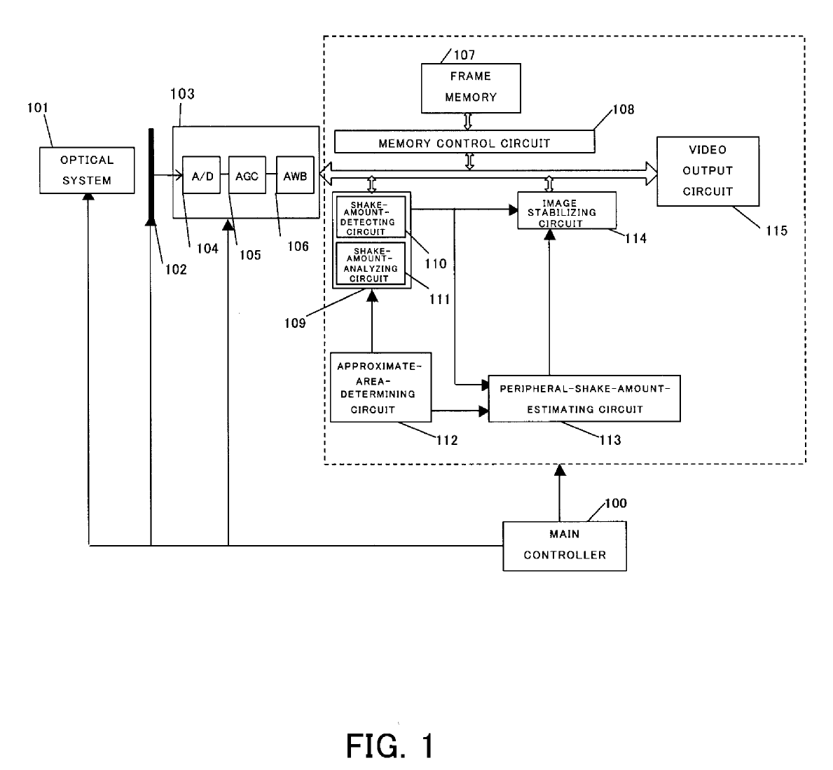

FIG. 1 shows the configuration of an image pickup apparatus that is Embodiment 1 according to the present invention. The image pickup apparatus includes an image pickup system and an image processing system (image processing apparatus) having an image-stabilizing function as described below.

In FIG. 1, reference numeral 101 denotes an optical system for forming an object image with a light flux from an object. Reference numeral 102 denotes an image pickup element such as a CCD sensor and a CMOS sensor that photoelectrically converts the object image formed by the optical system 101.

Reference numeral 103 denotes an image-generating part that generates a video signal from an electric signal output from the image pickup element 102. The image-generating part 103 includes an A/D converting circuit 104, an auto gain control circuit (AGC) 105 and an auto-white-balance circuit (AWB) 106, and generates a digital video signal.

The A/D converting circuit 104 converts an analog signal into a digital signal. The AGC 105 performs level correction on the digital signal, and the AWB 106 performs white level correction on a video.

Reference numeral 107 denotes a frame memory for temporary recording and storing one frame or a plurality of frames of the video signal generated by the image-generating part 103.

Reference numeral 108 denotes a memory control circuit that controls inputting a frame image to and outputting the frame image from the frame memory 107. The optical system 101 to the memory control circuit 108 described above constitute the image pickup system. The image processing system will be described as follows.

Reference numeral 109 denotes a shake analyzing part as a shake detecting part. The shake analyzing part detects an apparent shake caused by the image pickup apparatus (in other words, a shake in a first image area of an input image) in an approximate-perspective-projection area described later determined between mutually adjacent frame images by an approximate-area-determining circuit 112 described later, and analyzes a tendency of the shake. The shake analyzing part 109 is constituted by a shake-amount-detecting circuit 110 and a shake-amount-analyzing circuit 111.

Reference numeral 112 denotes the approximate-area-determining circuit (area determination part), and determines the image area (the first image area: referred to as the approximate-perspective-projection area hereinafter) that is approximatable by a perspectively-projected image on the image (input image) including the distortion generated by the image-generating part 103.

It is needless to say here, but the distortion referred to in the embodiment refers to the distortion included in the image having a certain size such as a fish-eye image picked up using a lens having other method than a perspective projection method such as a fish-eye lens and the image picked up using specifically a wide-angle range of a zoom optical system, as described in Embodiment 4 later. That is, a tiny distortion (can be recognized as no distortion) caused by aberrations which a normal optical system includes and should otherwise be removed is not included.

Reference numeral 113 denotes a peripheral-shake-amount-estimating circuit (shake information generating part) that estimates the shake amount in a peripheral image area (the second image area) of the approximate-perspective-projection area, based on the approximate-perspective-projection area determined by the approximate-area-determining circuit 112 and an amount of the shake (shake amount) detected by the shake analyzing part 109. The ‘shake amount’ referred to in this embodiment includes a direction of the shake.

Reference numeral 114 denotes an image stabilizing circuit (shake-reduction-processing part) that performs image stabilization (shake reduction processing) on the input image, based on the shake amount detected by the shake analyzing part 109 and an estimated shake amount (shake information) estimated by the peripheral-shake-amount-estimating circuit 113.

Reference numeral 115 denotes a video output circuit that constitutes an output part for displaying the image (video) with image stabilization performed on a display (not shown), for recording the image in a recording medium such as a semiconductor memory, an optical disk, and a magnetic tape.

Reference numeral 100 denotes a main controller that controls the image pickup element 102, the image-generating part 103, the memory control circuit 108, the shake analyzing part 109, the approximate-area-determining circuit 112, the peripheral-shake-amount-estimating circuit 113, the image stabilizing circuit 114, and the video output circuit 115. The main controller 100 is constituted by a CPU and the like.

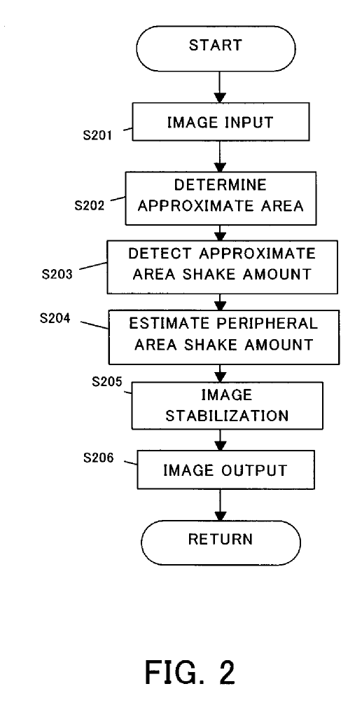

An operation of the image pickup apparatus (operation of the image processing system) constituted as described above will be explained using a flowchart shown in FIG. 2.

The operations described here are executed in accordance with a computer program (soft ware) stored in the memory (not shown) in the main controller 100. The operations are identically executed in other embodiments as follows.

In FIG. 2, at a step S201, an object image formed by the optical system 101 is photoelectrically converted by the image pickup element 102. The image pickup element 102 outputs an analog signal according to object luminance, and the analog signal is input into the image generating part 103. In the image generating part 103, the analog signal is converted, for example, into a 14-bit digital signal by the A/D converting circuit 104. Furthermore, the digital video signal (frame image as the input image) on which signal level correction by the AGC 105 and white level correction by the AWB 106 are performed is temporarily stored in the frame memory 107.

In the image pickup apparatus, frame images that are serially generated at a predetermined frame rate, and recorded and stored in the frame memory 107 are serially input into the shake analyzing part 109. The frame images to be stored in the frame memory 107 are serially updated. The above operation is controlled by the memory control circuit 108.

At a step S202, the approximate-perspective-projection area on the input frame picture is determined by the approximate-area-determining circuit 112.

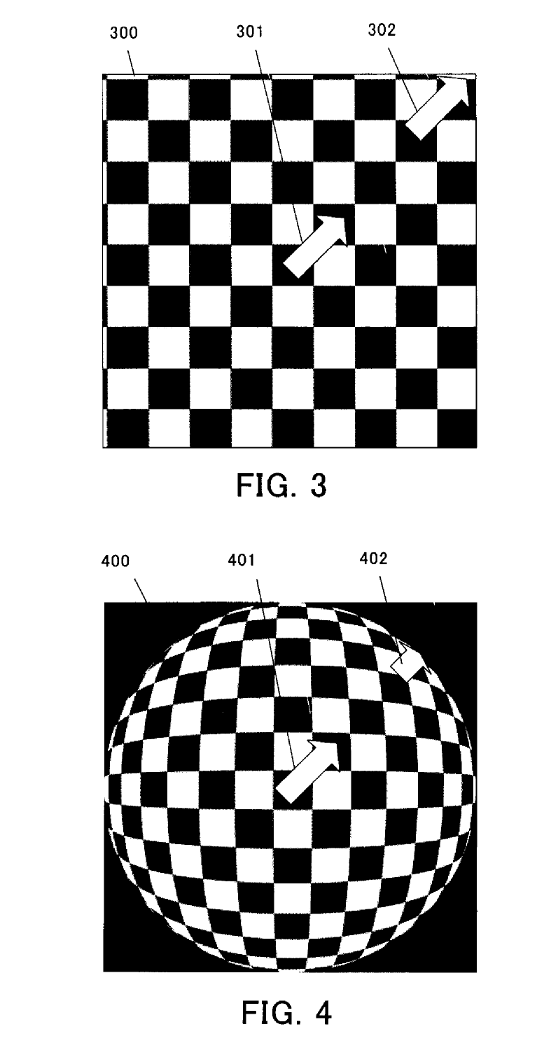

A method of determining the approximate-perspective-projection area in this embodiment will be described here. FIG. 3 shows the perspectively-projected image. FIG. 4 shows the fish-eye image by an orthogonal projection method as an example of the input image. In these figures, the objects are defined to have no movement.

In the perspectively-projected image 300, when an image height is defined as r, a view angle as θ, and a focal length of the optical system 101 as f, a relationship between the image height and the view angle is expressed as follows.

r=f tan θ (1)

Identically, in the fish-eye image 400, when the image height is defined as r, the view angle as θ, and the focal length of the optical system 101 as f, the relationship between the image height and the view angle is expressed as follows.

r=f sin θ (2)

Arrows 301 and 302 in FIG. 3 show apparent motion vectors on the perspectively-projected image 300. Each of the motion vectors shows a movement and a direction of the object image on the image that are caused by the shake of the image pickup apparatus with respect to the object. The motion vectors 301, 302 are identical in magnitude in any areas of the image 300.

In contrast, arrows 401, 402 in FIG. 4 show apparent motion vectors on the fish-eye image 400. On the fish-eye image 400, the larger the view angle (the higher the image height is) in the area is, that is, the closer to an outside of the image 400 the area is, the stronger distortion the apparent motion vector has.

As described above, the apparent motion vectors seen on the perspectively-projected image and those on the fish-eye image are greatly different from each other. Therefore, on performing image processing for correcting (reducing) the shake on the fish-eye image, it is necessary to take account of the distortion of the image.

However, as seen by the comparison of the motion vector 301 and the motion vector 401, the distortion is smaller in an area closer to a center (hereinafter referred to as simply a center area) of the fish-eye image 400, and the motion vector 401 in the center area is almost the same as the apparent motion vector on the perspectively-projected image. Therefore, the same image processing as that on the perspectively-projected image can be performed on an area where the apparent motion vector on the fish-eye image is approximatable by that on the perspectively-projected image.

The approximate-area-determining circuit 112 determines an area which is located on the fish-eye image and still can be handled the same as the perspectively-projected image as an approximate-perspective-projection area, and outputs a determination result to the analyzing part 109. In other words, a specific area on the fish-eye image is regarded as the approximate-perspective-projection area.

This embodiment describes the fish-eye image by the orthogonal projection method as an example of the input image. However, images including distortions in alternative embodiments according to the present invention are not limited to the fish-eye image, but images including distortions obtained by any projection method will work. Identically the approximate-perspective-projection area may be determined on the image including the distortion obtained by any projection method.

The perspectively-projected image is not always located in the center area of the image, but may be in an annular area surrounding the center area or an area away from the center area.

In FIG. 2, at a step S203, the motion vectors 401 in the approximate-perspective-projection areas between serial frame images are detected by the shake-amount-detecting circuit 110. A general detecting method such as a template matching method and a gradient method may be used for detecting a motion vector. There is no limitation for a method. At the step S203, the motion vectors are detected at a plurality of small blocks in the approximate-perspective-projection area.

The motion vectors at the plurality of small blocks detected by the shake-amount-detecting circuit 110 are integrated by the shake analyzing circuit 111, and a representative motion vector that represents a movement of the whole approximate-perspective-projection area is generated. The representative motion vector represents a detected shake amount (the shake on the first image area in the input image: may be referred to as detected shake information) to be detected in the approximate-perspective-projection area. This embodiment describes a case where the shake amount is detected by an image-processing-computation method using the frame image as the input image, however, the shake amount may be detected using a shake sensor such as an angular speed sensor.

At a step S204, the peripheral-shake-amount-estimating circuit 113 estimates the apparent shake amount (motion vector) in the peripheral area having the strong distortion outside the approximate-perspective-projection area, that is, estimates shake information on the shake on the second image area of the input image, based on the representative motion vector in the approximate-perspective-projection area output from the shake analyzing part 109.

A method of estimating the motion vector in the peripheral area will be described here. When the image includes the distortion, the apparent motion vector includes also the distortion in magnitude and direction thereof. However, the difference between the view angle position of the origin and that of the end is constant for any distortion. Accordingly, the motion vector in the approximate-perspective-projection area is analyzed into an x-direction and a y-direction, the difference between the view angle position of the origin and that of the end (that is a difference between image heights) for each direction is calculated. An arbitral coordinate point is defined as the origin. A position which is away by the difference of the calculated view angle position from the origin is defined as the end. A vector having the origin and the end represents a motion vector of the coordinate points.

More specifically details are explained as follows. First, when the image center is defined as the origin, the view angle position (that is an image height position) in an arbitrary coordinate is obtained, relating to the expression (2) as follows.

θ=sin⁻¹(r/f) (3)

Now the coordinate of the origin of the motion vector in the approximate-perspective-projection area is defined as follows.

R1=(X1,Y1) (4)

Then, the coordinate of the end of the same is defined as follows.

R1′=(X1′,Y1′) (5)

Then the difference in the x-direction between the view angle positions of the above two points is defined as Δθx, and that in the y-direction is defined as Δθy, the following expressions are obtained.

Δθx=sin⁻¹(X1′/f)−sin⁻¹(X1/f)

Δθy=sin⁻¹(Y1′/f)−sin⁻¹(Y1/f) (6)

Therefore, when the coordinate for estimating the motion vector is defined as

R2=(X2,Y2) (7),

the view angle positions are expressed as follows.

θx=sin⁻¹(X2/f)

θy=sin⁻¹(Y2/f) (8)

Thus, when the coordinate of the end of the motion vector is defined as

R2′=(X2′,Y2) (9),

the following expressions are obtained.

X2′=f sin(θx−θx)

Y2′=f sin(θy−Δθy) (10)

As described above, the motion vector (the estimated shake amount: also referred to as estimated shake information) in the peripheral area (every pixel or every small block) is estimated using the motion vector in the approximate-perspective-projection area and the difference between the view angle position in the peripheral area and that in the approximate-perspective-projection area. Thus, the motion vector can be obtained in every area of the whole-fish-eye image.

In FIG. 2, at a step S205, coordinate transformation processing as image stabilization is performed by the image stabilizing circuit 114 using the detected shake amount in the approximate-perspective-projection area obtained at the step S203 and the estimated shake amount in the peripheral area obtained at the step S204. More specifically, moving the pixel or the small block in the direction in which the shake at every pixel or every block can be cancelled enables a coordinate value of each of image-stabilized pixels to be calculated to generate a coordinate-value-transformation data for image stabilization.

The coordinate transformation processing is performed on the frame image recorded and stored in the frame memory 107, based on the generated coordinate-value-transformation data. The image constituted by the coordinate-transformed-pixel values is output to the video output circuit 115 as an image-stabilized image.

At a step S206, the image-stabilized image is output from the video output circuit 115 to the display or a recording medium.

As described above, in this embodiment, the approximate-perspective-projection area of the image including the distortion is determined, and the apparent shake amount (estimated shake information) in the area such as the peripheral area including the strong distortion outside the approximate-perspective-projection area (non-approximate area) is estimated based on the detected shake amount obtained the approximate-perspective-projection area (detected shake information). And the image stabilization is performed in the approximate-perspective-projection area based on the detected shake amount, and also the image stabilization is performed in the non-approximate area based on the estimated shake amount in the non-approximate area.

With the above processing, the shake-amount-detecting processing and the image stabilization on the whole image can be performed without transforming the whole input image including the distortion into the perspectively-projected image. Accordingly, the increase in the processing time can be suppressed, and an electric-image-stabilizing function that enables the image-stabilized image in a preferable condition that does not generate deterioration of the image quality caused by transforming the image to be obtained can be realized.

### Embodiment 2

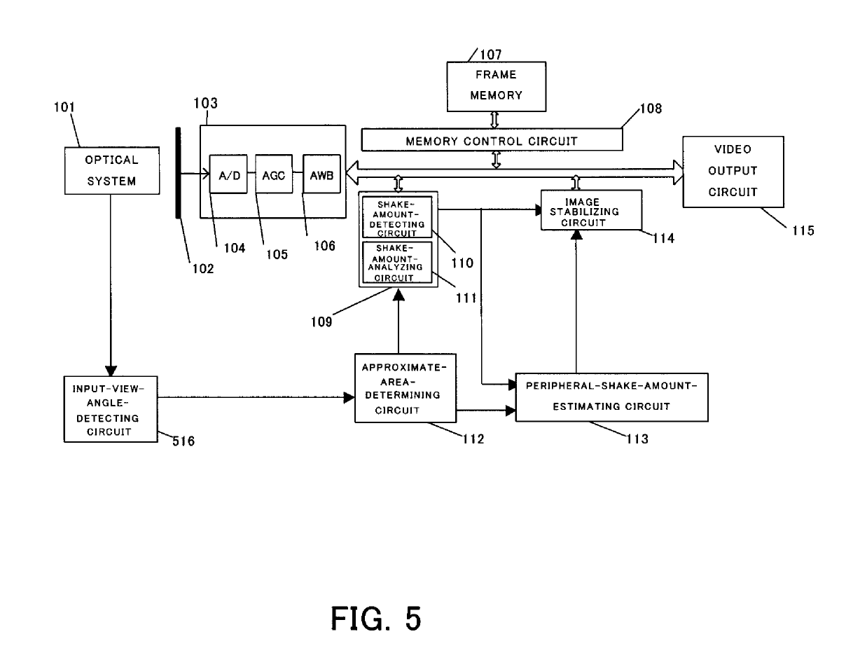

FIG. 5 shows the configuration of the image pickup apparatus that is Embodiment 2 according to the present invention. In this embodiment, the approximate-perspective-projection area is determined according to the size of the view angle of the input image.

An element in FIG. 5 common to that shown in FIG. 1 is designated with the same reference numeral.

The image pickup apparatus in this embodiment includes an input-view-angle-detecting circuit 516 that detects the view angle of the input image (referred to as input view angle hereinafter) as well as the configuration shown in FIG. 1. The main controller shown in FIG. 1 is omitted in FIG. 5.

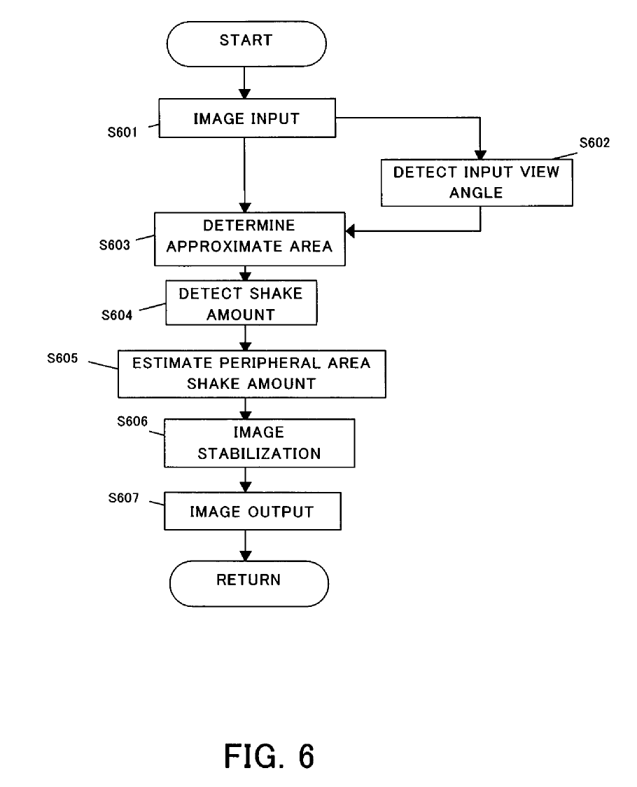

Operations of the image pickup apparatus in this embodiment will be described using a flowchart shown in FIG. 6 as follows.

A step S601 is identical to the step S201 shown in FIG. 2 of Embodiment 1.

At a step S602, the input view angle is calculated by the input-view-angle-detecting circuit 516 based on position information on the lenses constituting the optical system 101 and focal distance information on the optical system 101. The calculated input view angle is forwarded to the approximate-area-determining circuit 112.

At a step S603, the approximate-area-determining circuit 112 determines the approximate-perspective-projection area using the input image including the distortion obtained at the step S601 and the input view angle obtained at the step S602. In this embodiment, the approximate-perspective-projection area that is approximatable by the perspectively-projected image on the input image is determined by the comparison of a relationship between the view angle position and the image height on the input image including the distortion and that on the perspectively-projected image.

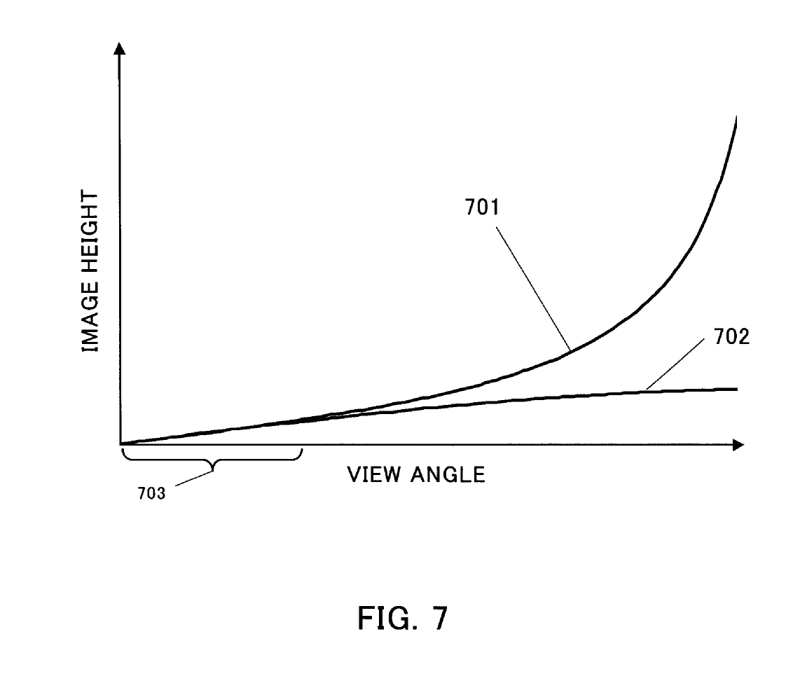

Now, a graph 702 in FIG. 7 indicates the relationship between the view angle and the image height on the approximate-perspective-projection area. And a graph 701 indicates the relationship between the view angle and the image height on the fish-eye image by the orthogonal projection method as an example of the input image including the distortion.

As shown in FIG. 7, there is a great difference between the image height at a position where the view angle is large on the perspectively-projected image and that on the fish-eye image. This is because that the larger the view angle is the stronger the distortion becomes on the fish-eye image. In contrast, the smaller the view angle position is, the smaller the difference between the image height on the fish-eye image and that on the perspectively-projected image becomes, thereby the image height on the perspectively-projected image and that on the fish-eye image are almost identical in the area indicated by reference numeral 703 in FIG. 7. This shows that an appearance of the change of the image height with respect to the view angle position on the perspectively-projected image and that on the fish-eye image are almost identical, when the view angle is small.

Accordingly, an area 703 can be determined as the approximate-perspective-projection area that is approximatable by the perspectively-projected image of the fish-eye image. The relationship between the view angle position and the image height on the fish-eye image and that on the approximate-perspective-projection area (data corresponding to the graph 701, 702 respectively) is stored in the memory (not shown) of the approximate-area-determining circuit 112. The approximate-perspective-projection area on the fish-eye image is determined from the relationship between the input view angle obtained at the step 602 and the input view angle corresponding to the area 703

The steps S604 to S607 are respectively identical to the steps S203 to S206 shown in FIG. 2 of Embodiment 1.

As described above, in this embodiment, the approximate-perspective-projection area in the input image is determined by the comparison of the relationship between the view angle position and the image height on the input image including the distortion and that on the perspectively-projected image. Moreover, the apparent shake amount is estimated in the non-approximate area such as the peripheral area, based on the detected shake amount obtained on the approximate-perspective-projection area. Then, the image stabilization is performed in the approximate-perspective-projection area based on the detected shake amount, and also the image stabilization is performed on the non-approximate area based on the estimated shake amount in the non-approximate area.

With the above processing, the shake-amount-detecting processing and the image stabilization on the whole image can be performed without transforming the whole input image including the distortion into the perspectively-projected image. Accordingly, the increase in the processing time can be suppressed, and an electronic-image-stabilizing function that enables the image-stabilized image in a preferable condition that does not generate deterioration of the image quality caused by transforming the image to be obtained can be realized.

### Embodiment 3

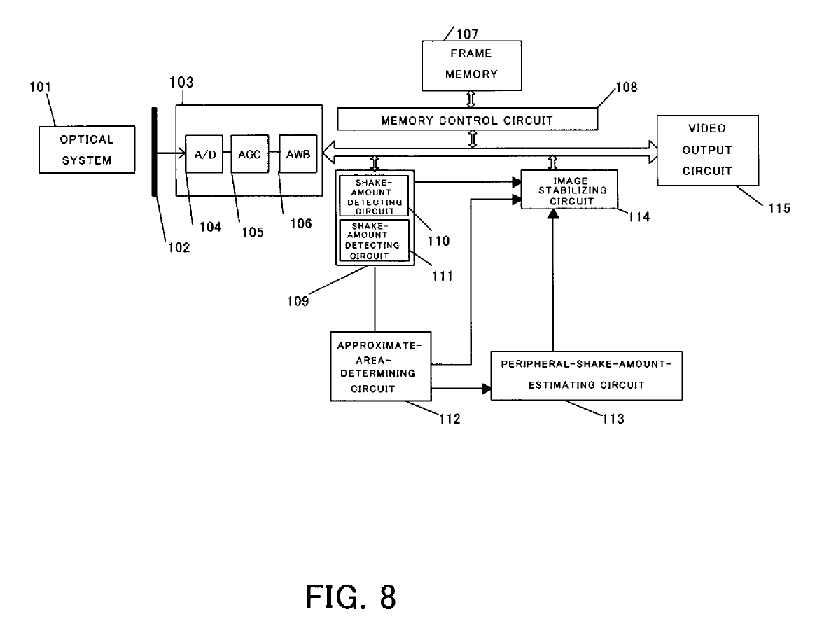

FIG. 8 shows the configuration of the image pickup apparatus that is Embodiment 3 according to the present invention. In this embodiment, the approximate-perspective-projection area in the input image is determined, based on the magnitude change of the apparent shake amount (motion vector) on the input image.

An element in FIG. 8 common to that shown in FIG. 1 is designated with the same reference numeral.

The image pickup apparatus in this embodiment, having the configuration different from that in FIG. 1, determines the approximate-perspective-projection area by forwarding the detected result of the shake amount obtained by the shake amount analyzing part 109 to the approximate-area-determining circuit 112. The main controller shown in FIG. 1 is omitted in FIG. 8.

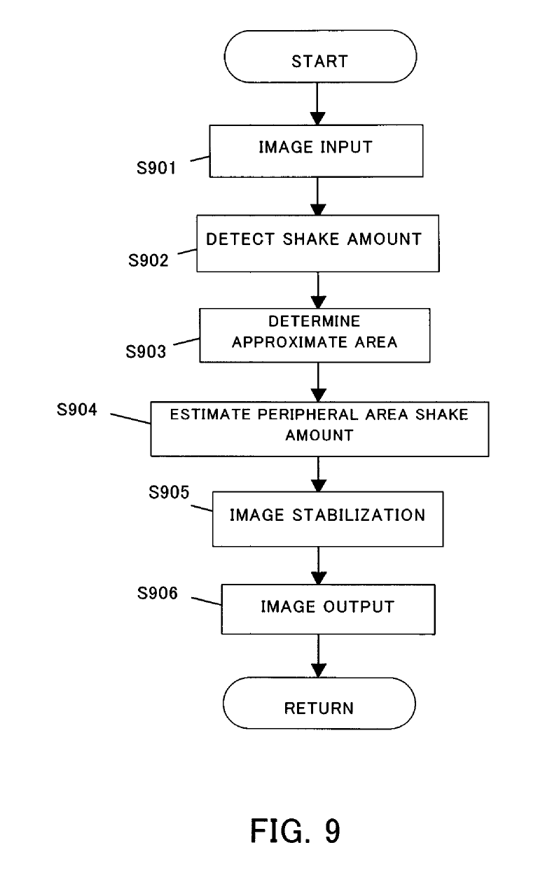

Operations of the image pickup apparatus in this embodiment will be described using a flowchart shown in FIG. 9 as follows.

A step S901 is identical to the step S201 shown in FIG. 2 of Embodiment 1.

At a step S902, the shake-amount-detecting circuit 110 calculates the shake amount (motion vector) in the plurality of areas from the center of the image to its vicinity between the serial frame images (input image). The calculated motion vector is forwarded to the approximate-area-determining circuit 112.

At a step S903, the approximate-area-determining circuit 112 determines the approximate-perspective-projection area in the input image, based on the motion vectors in the plurality of areas located in the vicinity to the image center, the motion vectors being calculated at the step S902.

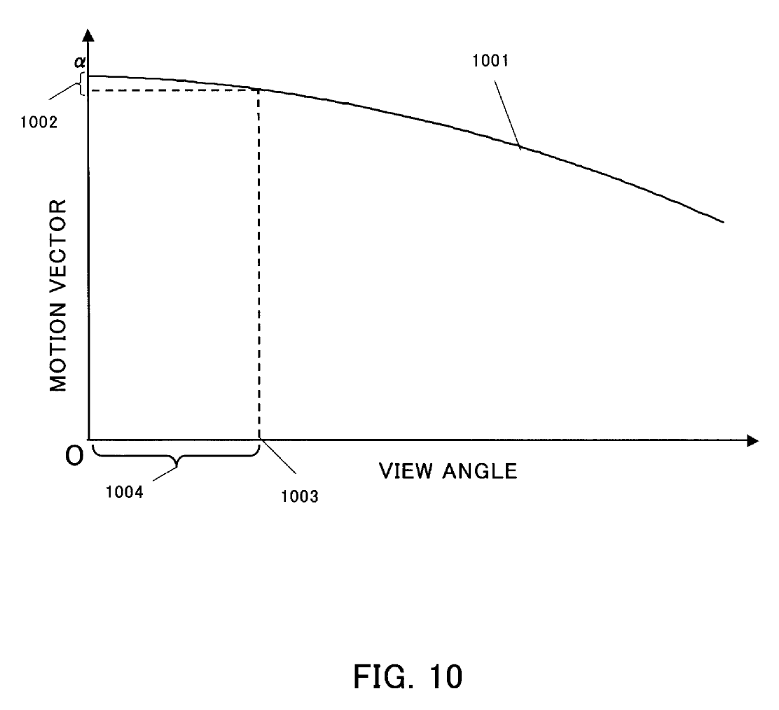

Now, a method of determining the approximatable area in this embodiment will be described. This embodiment describes the fish-eye image by the orthogonal projection method as an example of the input image. In FIG. 10, a graph 1001 indicates a relationship between the view angle and an apparent magnitude of the motion vector on the fish-eye image.

As shown in FIG. 10, the larger the view angle is, the smaller the apparent magnitude of the motion vector becomes, due to the distortion. Then a value acceptable for a change amount of the motion vector from the image center is defined as a threshold value, and at that point, the view angle position is defined as a boundary (outer end) of the approximate-perspective-projection area.

In FIG. 10, when the magnitude ‘α’ of the motion vector at a position where the view angle is 0 degrees (image center) changes as indicated by a graph 1001 along with the increase of the view angle, and when the change amount is within the acceptable value 1002, it is determined that the motion vector is located within the approximate-perspective-projection area. A graph 1003 indicates the view angle position corresponding to the upper limit of the acceptable amount 1002. That is, the area from the position of the view angle 0 degrees to the view angle position 1003 may be determined as the approximate-perspective-projection area.

This embodiment describes a case where a plurality of the motion-vector-detecting areas is set in an area that is located from the image center to its vicinity. However, as long as the area is within a range where the change of the motion vector with respect to the change of the view angle can be known, the motion-vector-detecting area may be set in other areas than the area described above. Moreover, the acceptable amount 1002 is defined depending on a ratio with respect to the magnitude of an original motion vector (for example, the magnitude of the motion vector at the image angle 0 degrees), the number of pixels and etc.

The information on the approximate-perspective-projection area determined as described above and on the motion vector in the approximate-perspective-projection area is forwarded to the peripheral-shake-amount-estimating circuit 113 and the image stabilization circuit 114.

Steps S904 to S906 in FIG. 9 are respectively identical to steps S204 to S206 in FIG. 2 of Embodiment 1.

As described above, in this embodiment, the approximate-perspective-projection area in the input image including the distortion is determined from the appearance of the change of the shake amount detected in the plurality of the areas on the input image. Furthermore, the apparent shake amount in the non-approximate area such as the peripheral area is estimated based on the detected shake amount obtained in the approximate-perspective-projection area. And the image stabilization in the approximate-perspective-projection area is performed based on the detected shake amount, and also the image stabilization is performed in the non-approximate area, based on the estimated shake amount in the non-approximate area.

With the above processing, the shake amount detecting processing and the image stabilization on the whole image can be performed without transforming the whole input image including the distortion into the perspectively-projected image. Accordingly, the increase in the processing time can be suppressed, and the electronic-image-stabilizing function that enables the image-stabilized image in a preferable condition that does not generate deterioration of the image quality caused by transforming the image to be obtained can be realized.

### Embodiment 4

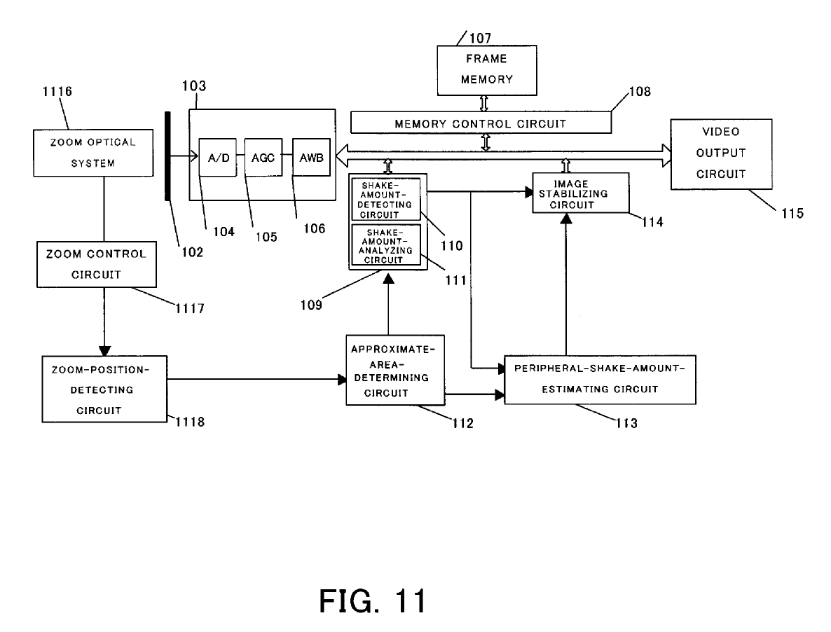

FIG. 11 shows the configuration of the image pickup apparatus that is Embodiment 4 according to the present invention. Each of the embodiments described above, explains a case where the shake on the fish-eye image picked up using the fish-eye lens as the optical system is corrected. The present invention, however, can also be applied to a case where the shake on the image including the distortion other than the fish-eye image is corrected. For example, there is a case where an image picked up using a wide-angle lens or a wide-angle range of a zoom optical system includes a strong distortion at a peripheral area thereof. The present invention can also be applied to this case.

The image pickup apparatus in this embodiment has the zoom optical system whose magnification is variable, and determines the approximate-perspective-projection area in the input image based on a zoom position (information on the magnification).

An element in FIG. 11 common to that shown in FIG. 1 is designated with the same reference numeral. The image pickup apparatus in this embodiment includes a zoom optical system 1116 instead of the optical system 101 shown in FIG. 1, and furthermore includes a zoom control circuit 1117 and a zoom-position-detecting circuit 1118 in addition to the configuration shown in FIG. 1. The main controller shown in FIG. 1 is omitted in FIG. 11.

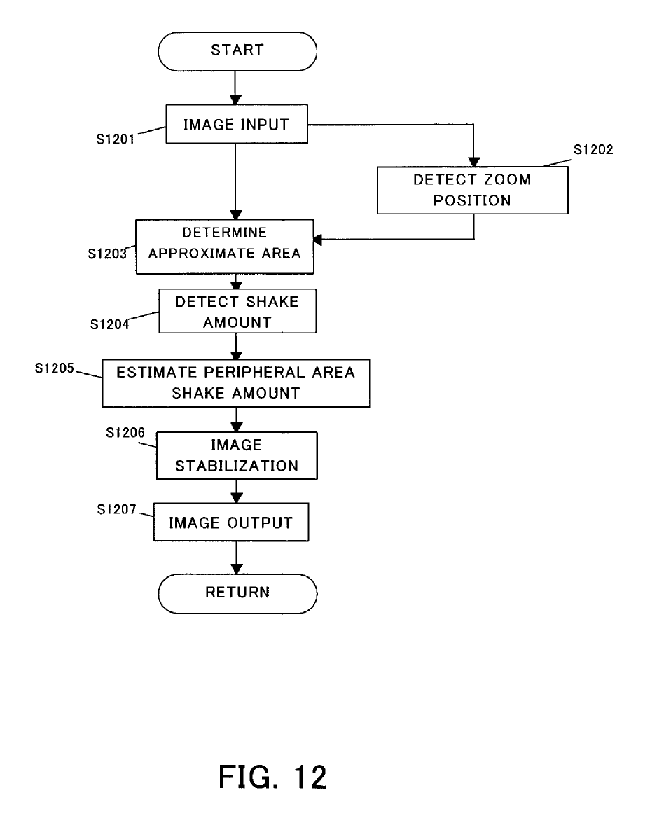

Operations of the image pickup apparatus in this embodiment will be described using a flowchart shown in FIG. 12 as follows.

A step S1201 is identical to the step S201 shown in FIG. 2 of Embodiment 1.

At a step S1202, the zoom position control circuit 1117 controls the zoom position of the zoom optical system 1116 responding to a zoom switch (not shown) operated by a user. And the zoom position is detected by the zoom-position-detecting circuit 1118. The information on the detected zoom position is forwarded to the approximate-area-determining circuit 112.

At a step S1203, the approximate-area-determining circuit 112 determines the approximate-perspective-projection area in the input image using the zoom position information obtained by the zoom-position-detecting circuit 1118.

Now, a method of determining the approximate-perspective-projection area in this embodiment will be described. In this embodiment, the zoom position information of the zoom optical system 1116 is obtained, and a characteristic of the magnitude change of the motion vector with respect to the coordinate position on the input image according to the zoom position is analyzed. Then, the approximate-perspective-projection area that is most suitable for being handled as the perspectively-projected image is determined from the analysis result.

When the zoom position of the zoom optical system 1116 is changed, the characteristic of the apparent magnitude of the motion vector on the input image also changes. For example, when the zoom position is moved toward a telephoto range, the apparent motion vector on the input image as well as the input image itself is enlarged. A ratio of the change of the motion vector with respect to the view angle position on the input image is decreased.

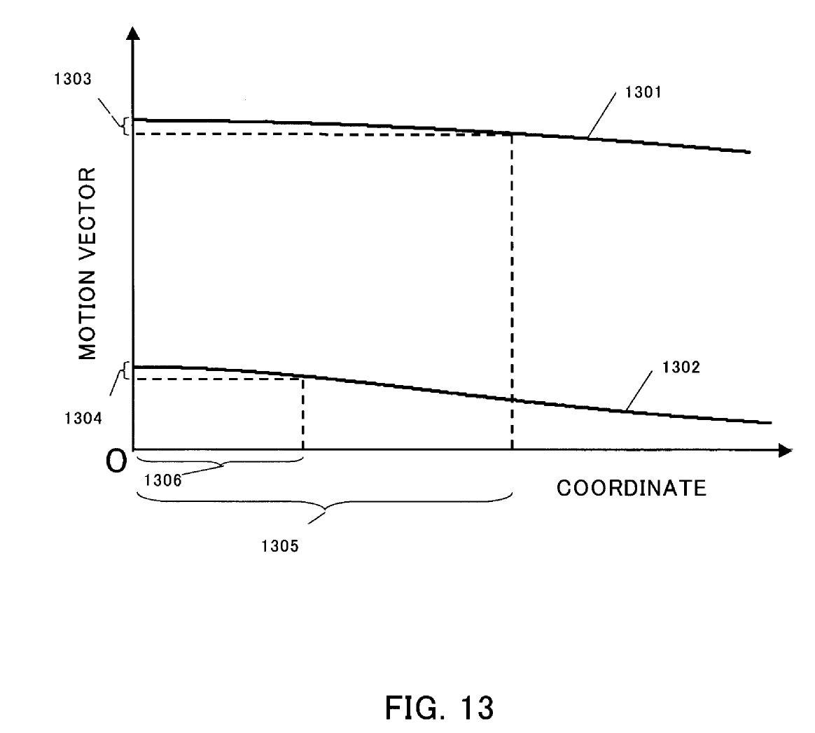

FIG. 13 shows the magnitude change of the motion vector in accordance with the coordinate position on the input image. In FIG. 13, a graph 1301 indicates the magnitude change of the motion vector with respect to the coordinate position when the zoom position of the zoom optical system 1116 is closer to the telephoto range. A graph 1302 indicates the magnitude change of the motion vector with respect to the coordinate position when the zoom position of the zoom optical system 1116 is closer to the wide-angle range.

When the zoom position is closer to the telephoto range, the center portion of the image that may become the approximate-perspective-projection area is enlarged to be picked up. Accordingly, the apparent change of the motion vector with respect to the coordinate position is slow.

In contrast, when the zoom position is closer to the wide-angle range, the peripheral area including the strong distortion is widely picked up. Accordingly, the apparent change of the motion vector in the peripheral area is steep.

Now, the acceptable amounts of the magnitude change of the motion vectors for determining the approximate-perspective-projection areas set as indicated by a portion 1303 for the telephoto range, and a portion 1034 for the wide-angle range.

At this point, when the acceptable amount 1303, 1304 at the telephoto range and the wide-angle range respectively are set identical, an outer end of the approximate-perspective-projection area is indicated by the coordinate 1305 at the telephoto range, and by the coordinate 1306 that is closer to the image center at the wide-angle range. In other words, when the image is picked up at the wide-angel range, since the area that may be the approximate-perspective-projection area is smaller than that at the telephoto range, the area including the strong distortion becomes wider. Therefore, when the image is picked up at the wide-angle range, specifically the image stabilization works effectively.

As described above, changing the size of the approximate-perspective-projection area according to the zoom position of the zoom optical system 1116 enables the detection of the shake amount to perform more accurately.

As shown in FIG. 12, the steps S1204 to S1207 are respectively identical to the steps S203 to S206 shown in FIG. 2 in Embodiment 1.

As described above, in this embodiment, the approximate-perspective-projection area is determined on the input image based on the zoom position information of the zoom optical system. Furthermore, the apparent shake amount on the non-approximate area such as the peripheral area is estimated. Then the image stabilization is performed in the approximate-perspective-projection area based on the detected shake amount, and also the image stabilization is performed in the non-approximate area based on the estimated shake amount in the non-approximate area.

With the above processing, the shake-amount-detecting processing and the image stabilization on the whole image can be performed without transforming the whole image including the distortion into the perspectively-projected image. Accordingly, the increase in the processing time can be suppressed, and an electronic-image-stabilizing function that enables the image-stabilized image in a preferable condition that does not generate deterioration of the image quality by transforming the image to be obtained can be realized.

Each of the embodiments described above, explains a case where the approximate-area-determining circuit 112 determines the suitable approximate-perspective-projection area, based on the information on the view angle, the zoom position and the like. However, the present invention is not limited to the case. For example, the image processing apparatus and the image pickup apparatus may be arranged so that the approximate-perspective-projection area most suitable for the pickup conditions may be arbitrarily selected by a manual operation of the operating members such as a switch by a user.

### Embodiment 5

Each of the embodiments described above, explains a case where the image processing apparatus includes a built-in image processing apparatus having the image-stabilizing function. However, the present invention is not limited to the case.

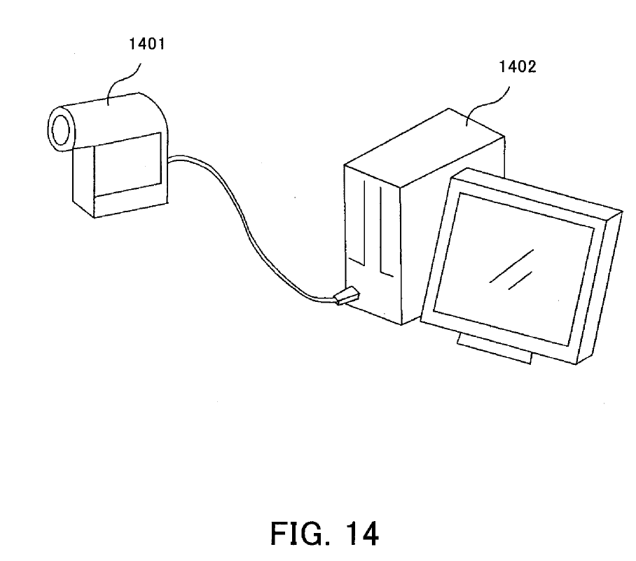

For example, as shown in FIG. 14, the image picked up by the image pickup apparatus 1401 is transmitted to a personal computer 1402. A method of transmitting may be any of a cable method and a wireless method, and transmission may be performed via the Internet or the LAN.

Image stabilization shown in the flowcharts in FIGS. 2, 6, 9 and 12 may be performed in the personal computer 1402.

In this case, the personal computer functions as the image processing apparatus for the present invention.

In this case, the shake amount (motion vector) may be detected by the personal computer. Or it is also possible that the personal computer takes in an output from the shake sensor mounted in the image pickup apparatus or that from the detecting circuit of the motion vector.

As described above, in accordance with the above embodiments, the output image including the distortion that has a reduced image shake can be obtained without performing the image processing for reducing the distortion on the image including the distortion. Therefore, the electronic-image-stabilizing function that enables the processing to speed up and the image including the reduced shake in a preferable condition that generates less deterioration of the image quality to be obtained can be realized.

Furthermore, the present invention is not limited to these preferred embodiments and various variations and modifications may be made without departing from the scope of the present invention.

This application claims foreign priority benefits based on Japanese Patent Application No. 2006-344568, filed on Dec. 21, 2006, which is hereby incorporated by reference herein in its entirety as if fully set forth herein.

What is claimed is:

1. An image processing apparatus comprising:
a shake detecting part that detects a shake in a first image area of an input image including a distortion;
a shake information generating part that generates shake information on a shake in a second image area of the input image based on the shake detected by the shake detecting part; and
a shake reduction processing part that performs image processing for reducing the shake in the second image area based on the shake information without performing image processing for reducing the distortion on the input image.

2. An image processing apparatus according to claim 1, wherein the input image is picked up by a projection method other than a perspective projection method.

3. An image processing apparatus according to claim 1, wherein the first image area is an area approximatable by a perspectively-projected image in the input image, and
wherein the image processing apparatus includes an area determining part that determines the first image area in the input image.

4. An image processing apparatus according to claim 3, further comprising a view angle detecting part that detects a view angle of the input image,
wherein the area determining part determines the first image area based on the view angle detected by the view angle detecting part.

5. An image processing apparatus according to claim 3, wherein the area determining part detects shakes in a plurality of image areas of the input image, and determines the first image area based on a detected result of the shakes in the plurality of image areas.

6. An image processing apparatus according to claim 3,
wherein the input image is obtained using an optical system whose magnification is variable, and
wherein the area determining part determines the first image area on the basis of information on the magnification of the optical system.

7. An image processing apparatus according to claim 1, wherein the shake reduction processing part performs reduction processing for reducing the shake in the first image area based on the shake detected by the shake detecting part.

8. An image pickup apparatus comprising:
an image pickup system that generates an input image using an optical system and an image pickup element; and
an image processing apparatus according to claim 1.

9. An image processing method comprising the steps of:
detecting a shake in a first image area of an input image including a distortion;
generating shake information on a shake in a second image area of the input image based on the shake detected in the first image area; and
performing image processing for reducing the shake in the second image area based on the shake information without performing image processing for reducing the distortion on the input image.
